(19) United States
(12) Patent Application Publication
(10) Pub. No.: US 2017/0195571 A1
(43) Pub. Date: Jul. 6, 2017

(54) CUSTOMISABLE MODES

(71) Applicant: OCLU LLC, TEMPE, AZ (US)

(72) Inventors: FIRAS KITTANEH, TEMPE, AZ (US); HUGO MARTIN, Oxfordshire (GB); Gregory Dean Hall, Johannesburg (ZA)

(73) Assignee: OCLU LLC., TEMPE, AZ (US)

(21) Appl. No.: 15/084,214

(22) Filed: Mar. 29, 2016

(30) Foreign Application Priority Data
Jan. 5, 2016 (GB) 1600166.1

(51) Int. Cl. H04N 5/232; H04N 5/77

(52) U.S. Cl. CPC H04N 5/23245; H04N 5/772; H04N 5/23216

(57) ABSTRACT

The present invention relates to a video recording device comprising:
a housing; a camera unit mounted in the housing and operable to receive an optical input and to output a video data stream relating to a received optical input; a user input means mounted in the housing and arranged to be operable by a user of the device, and operable to provide user input signals for the device; a data storage unit mounted in the housing and operable to store data therein; a processing unit mounted in the housing and operable to receive a video data stream from the camera device, to receive user input signals from the user input means, and to control data storage in the data storage device; wherein the processing unit has a plurality of modes of operation, and is operable to adjust at least one parameter of at least one of those modes of operation to produce an adjusted mode in response to receipt of a user input signal from the user input means mounted in the housing, and to store that adjusted mode, the processing unit being further operable to switch to and from such an adjusted mode of operation.

The present invention further provides a method of adjusting a mode of operation, and a method of selecting a mode of operation of such a video recording device.

The present invention provides a video recording device with one or more adjustable modes of operation. The present invention further provides a method of adjusting a mode of operation of such a video recording device.

When using a video recording device, the user typically has the option to select one of a plurality of modes that best suits the recording that they wish to make. Each mode may contain everything from the overall shoot mode type to the more minor settings that make up a mode.

Such overall shoot mode types may include one or more of simple video recording, time lapse shooting, video loop recording, single photo recording, multi-photo recording, and the like.

More minor settings that make up a mode, depending on the mode, may include parameters such as resolution, GPS on/off, video speed (i.e. frames per second), resolution, duration timers, loop duration, and the like.

Appropriate selection of the desired mode allows the user to obtain the desired recording type, duration and appropriate settings to maximize the recording quality. It is also important to note that a user may require more than one version of each mode with different setting configurations. For example, a user may wish to record full HD film at a number of different frame rates e.g. 360 fps (frames per second) for long clips where slow motion will not be used; 60 fps where the footage is slowed down to half speed; and 120-240 fps for very short video clips that will be played back in slow motion. The use of 240 fps for all footage would be impractical as the resulting files would be excessive in size and recording such footage would very quickly drain the camera battery. However, in convention cameras the user would need to adjust the frame rate each time they wished to alter between each version. This is clearly time consuming and undesirable. Further, when taking into account the various parameters that could be varied in each mode, it would take a user a significant amount of time to reselect each specific parameter within a selected mode type each time the camera mode selection is to be adjusted.

Although most video recording devices have one or more pre-programmed modes which can be selected by a user to best match desired mode types (e.g. simple video recording) and mode-type parameters (e.g. frames per second), the parameters of such modes are pre-programmed and therefore limit the options of the user.

There is therefore a need for a video recording device that allows a user to manually adjust the parameters of one or more modes locally and save such adjusted modes for future use, as well as switch quickly between such saved modes.

The present invention seeks to address the problems of the prior art.

Accordingly, a first aspect of the present invention provides a video recording device comprising:

a housing;

a camera unit mounted in the housing and operable to receive an optical input and to output a video data stream relating to a received optical input;

a user input means mounted in the housing and arranged to be operable by a user of the device, and operable to provide user input signals for the device;

a data storage unit mounted in the housing and operable to store data therein;

a processing unit mounted in the housing and operable to receive a video data stream from the camera unit, to receive user input signals from the user input means, and to control data storage in the data storage device;

wherein the processing unit has a plurality of modes of operation, and is operable to adjust at least one parameter of at least one of those modes of operation to produce an adjusted mode in response to receipt of a user input signal from the user input means mounted in the housing, and to store that adjusted mode, the processing unit being further operable to switch to and from such an adjusted mode of operation.

In this way, a user can adjust one or more parameters of a mode of operation of a video recording device and save the adjusted mode for future use.

In one embodiment, the processing unit is operable to switch from the adjusted mode of operation to a next mode of operation in dependence upon receipt of a further user input signal from the user input means.

The further user input signal may request that the processing unit switches sequentially through the various modes of operation available to the processing device, or may switch to a specifically selected mode of operation on receipt of a corresponding signal from a user.

In a further embodiment, the processing unit is operable to adjust at least one parameter of a plurality of the modes of operation to produce a plurality of adjusted modes in response to receipt of a user input signal from the user input means, and to store each of the adjusted modes, the processing unit being further operable to switch between such adjusted modes of operation.

Thus, a user may create an array of adjusted modes to suit the type of recording they wish to make (e.g. simple video recording, time lapse recording, video loop recording, single photo recording, multi-shot photo recording etc.) and define the parameters of each version of each mode. This results in a customised selection of modes of operation specific to that specific user. It is to be appreciate that, once a selection of adjusted modes of operation has been created by a user, the user is able at any future date to subsequently further adjust any one or more modes of operation, as desired. Alternatively, the user may provide a user input to the user input means to return one or more adjusted modes of operation back to their original factory settings as a default option.

A second aspect of the present invention provides a method of adjusting a mode of operation of a video recording device, the method comprising the steps of:

a. providing a video recording device according to any preceding claim;

b. providing a user input signal to the user input means to adjust at least one parameter of at least one mode of operation to produce an adjusted mode and store the adjusted mode of operation.

A third aspect of the present invention provides a method of selecting a mode of operation of a video recording device, the method comprising the steps of:

a. carrying out the method in accordance with a second aspect of the present invention; and

b. providing a further user input signal to the user input means to switch to and from the adjusted mode of operation to select a mode of operation.

An embodiment of the present invention will now be described, by way of example only, and with reference to the following drawings, in which:

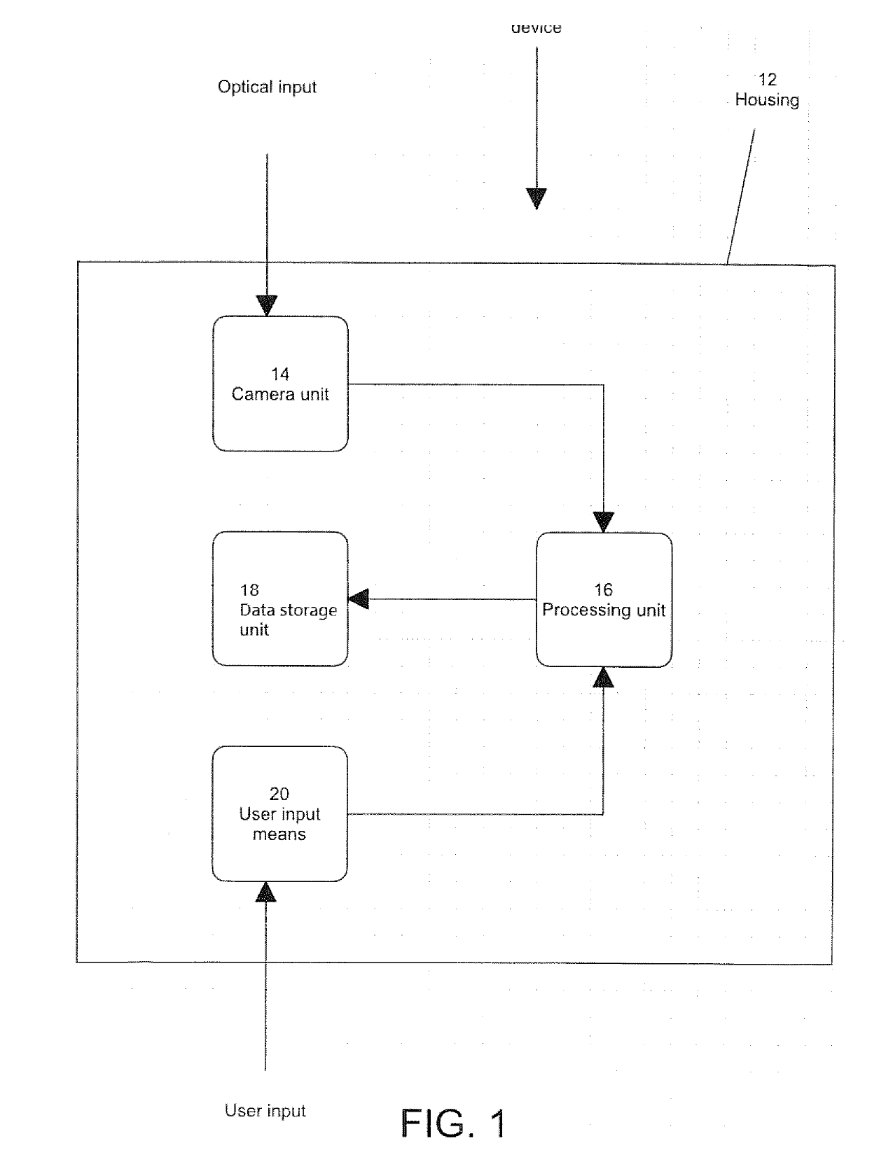

FIG. 1 is a diagrammatic representation of a first embodiment of a video recording device in accordance with a first aspect of the present invention; and

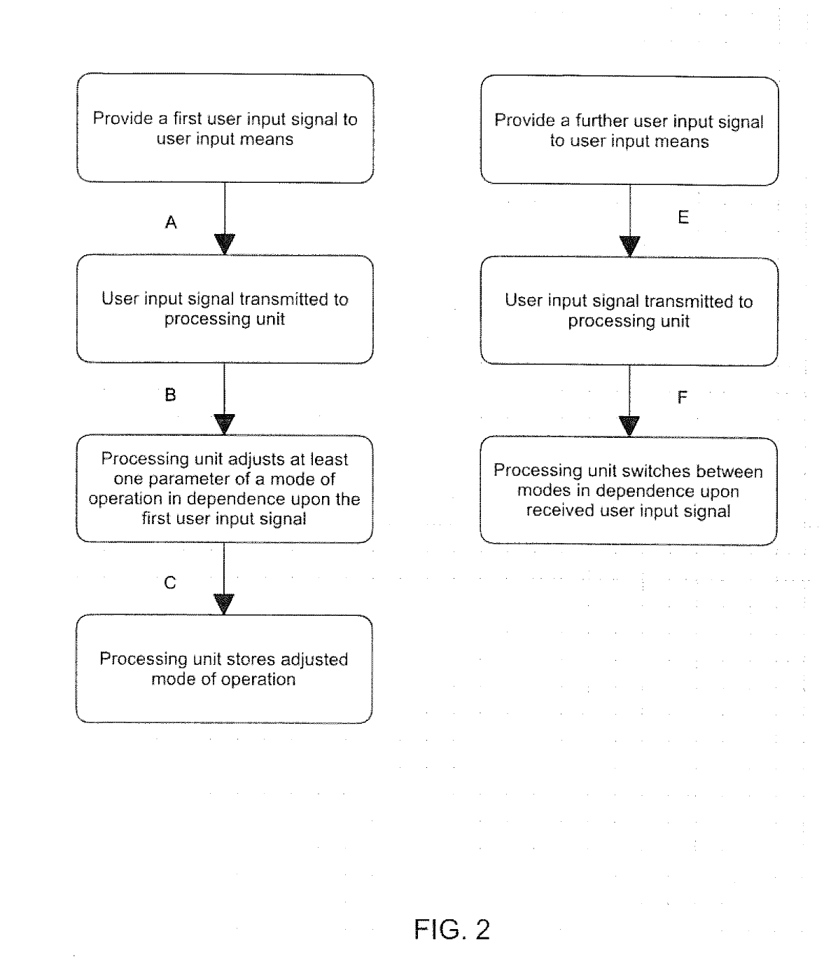

FIG. 2 is a flow diagram illustrating a method of adjusting a mode of operation of the device of FIG. 1, in accordance with a second aspect of the present invention, and a method of selecting a mode of operation of the device of FIG. 1 in accordance with a third aspect of the present invention.

FIG. 1 shows a video recording device 10 comprising a housing 12 containing a camera unit 14, a processing unit 16, a data storage unit 18 and a user input means 20.

Camera unit 14 is operable to receive an optical input and to output a corresponding video data stream relating to the received optical input. The camera unit 14 is in electrical communication with processing unit 14 and operable to transmit received the video data stream to processing unit 14.

On receipt of video data stream from camera unit 14, processing unit 14 is operable to control the storage of received video data in data storage unit 18.

User input means 20 is provided to receive user input signals from a user. For example, the user input means 20 may comprise a button or toggle switch or touch screen user interface provided on housing 12 and acts as a user interface for video recording device 10.

User input means 20 is in electric communication with processing unit 16 and, on receipt of a user input, is operable to transmit a user input signal corresponding to the user input to processing unit 16.

Processing unit 16 has a plurality of modes of operation which may be selected by a user, via user input means 20, when using video recording device 10 to record video footage or single or multi-photo recordings.

Each mode of operation has one or more parameters which may be adjusted by processing unit 16 on receipt of a user input signal from user input means 20.

Such modes of operation may include, but are not restricted to, simple video recording, time lapse shooting, video loop recording, single photo recording, and multi-photo recording.

Such parameters may include, but are not restricted to, one or more of video speed (frames per second (fps)), resolution (e.g. HD, Fully HD), ISO limit, spot metering, white balance, still image settings, ISO, image resolution, and GPS on/off. It is to be appreciated that this list is not exhaustive and any other variable parameters known to the skilled person may be considered as customizable parameters within the scope of the present invention.

Once adjusted to produce an adjusted mode, the adjusted mode parameters are stored by processing unit 16. Processing unit 16 is further operable to switch to and from the adjusted mode to other pre-programmed modes stored by the processing unit 16. One or more of the other pre-programmed modes may also be adjustable in dependence upon receive user input at user input means 20.

FIG. 2 is a flow diagram illustrating the methods of use of the video recording device of FIG. 1.

When a user wishes to customise one or more parameters of a mode of operation of a video recording device, a user provides a first user input at user input means 20 of video recording device 10 specifying the requested parameter adjustment. The user input means 20 then transmits a corresponding user input signal from user input means 20 to processing unit 16 (step A).

On receipt of such a user input signal, processing unit 16 adjusts the mode of operation in accordance with the user input signal (step B) to produce an adjusted mode of operation. For example, a user may wish to alter the video speed when making a simple video recording or may wish to alter the loop duration of a video loop recording.

Processing unit 16 then stores the adjusted mode of operation containing the requested parameter adjustment (step C) such that the adjusted mode of operation with the requested parameter adjustment is available to a user at any future point on request, provided that the user does not delete or further adjust the mode of operation parameters, or reset the video recording device to return all settings back to the original manufacturer's default settings.

Thus, a user may adjust a mode of operation of a video recording device in accordance with a second aspect of the present invention.

Processing unit 14 is further operable to switch to and from the stored adjusted mode of operation. This involves a user providing a second user input at user input means 20 of video recording device 10, requesting that the processing unit 14 switches between modes of operation. For example, a user may switch between simple video recording mode and single photo recording mode, or between any other modes or versions of similar modes. The user input means 20 then transmits a corresponding user input signal from user input means 20 to processing unit 16 (step E). In dependence upon the receive user input signal the processing unit 16 switches between modes of operation (step F).

It is to be appreciated that the ability of a user to adjust a mode of operation, which is then stored and available for future use, is advantageous over prior art arrangements where a user records video footage in similar environments and wishes to be able to set up the recording operation quickly and efficiently. For example, where the video recording device is an action camera, the user will very quickly be able to switch between different mode types or versions of mode types with pre-customised parameters. Therefore, if a user has been using simple video recording mode and wishes to switch to another version of the same mode type with a lower frames per second setting then this can easily and quickly be achieved. The saved adjusted parameters allow ease of operation of the camera without the requirement to have to re-input the mode parameter adjustments prior to use.

Similarly, switching between mode-types can be achieved in the same quick and efficient manner.

1. A video recording device comprising:
a housing;
a camera unit mounted in the housing and operable to receive an optical input and to output a video data stream relating to a received optical input;
a user input means mounted in the housing and arranged to be operable by a user of the device, and operable to provide user input signals for the device;
a data storage unit mounted in the housing and operable to store data therein;
a processing unit mounted in the housing and operable to receive a video data stream from the camera unit, to receive user input signals from the user input means, and to control data storage in the data storage device;
wherein the processing unit has a plurality of modes of operation, and is operable to adjust at least one parameter of at least one of those modes of operation to produce an adjusted mode in response to receipt of a user input signal from the user input means mounted in the housing, and to store that adjusted mode, the processing unit being further operable to switch to and from such an adjusted mode of operation.

2. A video recording device according to claim 1, wherein the processing unit is operable to switch from the adjusted mode of operation to a next mode of operation in dependence upon receipt of a further user input signal from the user input means.

3. A video recording device according to claim 1 or claim 2, wherein the processing unit is operable to adjust at least one parameter of a plurality of the modes of operation to produce a plurality of adjusted modes in response to receipt of a user input signal from the user input means, and to store each of the adjusted modes, the processing unit being further operable to switch between such adjusted modes of operation.

4. A method of adjusting a mode of operation of a video recording device, the method comprising the steps of:
a. providing a video recording device according to any preceding claim;
b. providing a user input signal to the user input means to adjust at least one parameter of at least one mode of operation to produce an adjusted mode and store the adjusted mode of operation.

5. A method of selecting a mode of operation of a video recording device, the method comprising the steps of:
a. carrying out the method of claim 4; and
b. providing a further user input signal to the user input means to switch to and from the adjusted mode of operation to select a mode of operation.
